(19) United States
(12) Patent Application Publication
(10) Pub. No.: US 2025/0356561 A1
(43) Pub. Date: Nov. 20, 2025

(54) SPATIOTEMPORAL ATTENTION IN GENERATIVE MACHINE LEARNING MODELS

(71) Applicant: QUALCOMM Incorporated, San Diego, CA (US)

(72) Inventors: Seokeon CHOI, Yongin-si (KR); Sunghyun PARK, Seoul (KR); Sungrack YUN, Seongnam (KR)

(21) Appl. No.: 19/019,882

(22) Filed: Jan. 14, 2025

Related U.S. Application Data
(60) Provisional application No. 63/647,422, filed on May 14, 2024.

(51) Int. Cl. G06T 13/00; G06T 11/00

(52) U.S. Cl. CPC G06T 13/00; G06T 11/00

(57) ABSTRACT

Certain aspects of the present disclosure provide techniques and apparatus for improved machine learning. In an example method, a transformed version of image pixels is accessed in a machine learning model trained to provide controllability of generated videos. A spatial version of the image pixels is generated using a spatial attention component, and a temporal version of the image pixels is generated using a temporal attention component. A spatiotemporal version of the image pixels is generated using a spatiotemporal attention component. An output version of the image pixels is generated based on the spatiotemporal version of the image pixels and at least one of the spatial version of the image pixels or the temporal version of the image pixels. A set of output image pixels from the machine learning model is generated based on the output version of the image pixels, the output pixels portraying motion from prompt video data.

### CROSS-REFERENCE TO RELATED APPLICATION(S)

The present application for patent claims the benefit of and priority to U.S. Provisional Patent Application No. 63/647,422, filed May 14, 2024, which is hereby incorporated by reference herein in its entirety for all applicable purposes.

### INTRODUCTION

Aspects of the present disclosure relate to machine learning.

A wide variety of machine learning model architectures have been trained to perform an assortment of diverse tasks, including computer vision tasks, language tasks, classification tasks, regression tasks, and the like. Recently, research has yielded substantial success in using large language models (LLMs), large vison models (LVMs), latent diffusion models (LDMs), and the like to process and generate output data. Often, machine learning models (especially LLMs, LVMs, and LDMs) have many parameters (e.g., millions or even billions), resulting in significant model size, as well as substantial computational expense in training the model. Further, once trained, such models are often difficult (or impossible) to fine-tune, as the vast number of parameters makes overfitting (where the model fits too closely to the training data, resulting in loss of accuracy and generalization for runtime data) a major challenge (e.g., potentially forcing reliance on tremendous amounts of fine-tuning data to prevent overfitting).

One recent approach to enable fine-tuning or personalization of such generative models involves training relatively smaller model adapters for larger models. For example, adapters may be trained to improve or enable video generation based on desired appearances, movement, and the like.

### BRIEF SUMMARY

Certain aspects of the present disclosure provide a processor-implemented method, comprising: accessing a transformed version of image pixels in a machine learning model trained to provide controllability of generated videos; generating a spatial version of the image pixels based on the transformed version of image pixels using a spatial attention component; generating a temporal version of the image pixels based on the transformed version of image pixels using a temporal attention component; generating a first spatiotemporal version of the image pixels based on processing at least one of the transformed version of image pixels, the spatial version of the image pixels, or the temporal version of the image pixels using a first spatiotemporal attention component; generating an output version of the image pixels based on the first spatiotemporal version of the image pixels and at least one of the spatial version of the image pixels or the temporal version of the image pixels; and generating a set of output image pixels from the machine learning model based on the output version of the image pixels, wherein the set of output image pixels portray motion depicted in prompt video data for the machine learning model.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict certain aspects of the present disclosure and are therefore not to be considered limiting of the scope of this disclosure.

FIG. 1 depicts an example workflow for video generation using machine learning models, according to some aspects of the present disclosure.

FIG. 2 depicts example attention mechanisms for generative machine learning, according to some aspects of the present disclosure.

FIG. 3 depicts example architectures for generative machine learning, according to some aspects of the present disclosure.

FIG. 4 depicts an example architecture for spatiotemporal attention in generative machine learning models, according to some aspects of the present disclosure.

FIG. 5 is a flow diagram depicting an example method for training spatiotemporal attention components for generative machine learning, according to some aspects of the present disclosure.

FIG. 6 is a flow diagram depicting an example method for generating video output using spatiotemporal attention, according to some aspects of the present disclosure.

FIG. 7 is a flow diagram depicting an example method for spatiotemporal attention, according to some aspects of the present disclosure.

FIG. 8 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and non-transitory computer-readable mediums for providing improved machine learning.

There has been significant recent development of multi-modal generative machine learning models, such as text-to-video generation models. However, it remains highly challenging to reproduce specific objects, appearances, and/or camera or object movements based on text prompts alone. To address these limitations, some conventional approaches use motion customization by personalizing text-to-video generation models using a few reference videos to enhance user control over video content (e.g., to allow more granular specification of desired motions through video inputs).

The development of diffusion models (e.g., LDMs) has markedly enhanced text-to-video generation capabilities using large-scale text-video training datasets. While some conventional text-to-video generation models can produce high-quality videos based on user-input text, specific information about object movements and/or camera movements in the generated videos often cannot be accurately described by text. Therefore, reproducing particular appearances or motions of objects in videos remains challenging.

In some aspects, model personalization is used to provide enhanced controllability of object and/or camera movements by allowing users to specify target motions through video inputs. A significant challenge of motion customization for some conventional solutions is to learn both visual appearance and motion appropriately by considering the disentanglement and entanglement between these factors. Although some recent approaches have tried to disentangle subject appearance and motion, some conventional techniques show substantial limitations in customizing both motions from reference videos and subject appearance from reference images for generating videos.

In some aspects of the present disclosure, therefore a low-rank adaptation (LoRA) fine-tuning technique that leverages LoRAs for learning subject appearance and motion of interest are provided. In some aspects, in multi-modal generative models (e.g., text-to-video generation models) including spatial attention and temporal attention blocks, spatial LoRAs can be used to learn subject-specific features for visual appearance from the spatial attention block. For the motion of interest, both spatial and temporal attention blocks may be used to learn motion-related features. During inference, the spatial and temporal LoRAs can be leveraged with textual prompts to generate a new video that contains or depicts the specific visual appearance and motion of interest.

In some aspects, to better capture motion dynamics, a spatiotemporal (sometimes referred to as a spatial-temporal) attention block is provided. Such spatiotemporal blocks may be added to spatial and/or temporal attention blocks as a residual structure to substantially improve model performance. In some aspects, the spatiotemporal attention blocks can operate based on local tubelets, which can help mitigate overfitting problems and reduce excessive complexity. Advantageously, aspects of the present disclosure can enhance the learning of disentangled appearance and motion features while fine-tuning the model(s) for personalization. In some aspects of the present disclosure, current limitations in accurately customizing both motion and appearance are overcome or at least reduced, thereby enhancing the expressiveness and controllability of generated videos. That is, aspects of the present disclosure can improve the degree of control users may exert over the content, structure, and/or format of the data (e.g., video) generated using the machine learning model(s). For example, the generated videos may depict motion and/or appearance that is closer to the target motion depicted in the prompt video(s) and/or the target appearance depicted in the prompt image(s), as compared to some conventional solutions. That is, the generated video may portray the motion and/or appearance depicted in the prompt videos and/or images (e.g., aligning or appearing similar to the depicted motion and/or appearance, while potentially differing in some relatively small ways).

### Example Workflow for Video Generation Using Machine Learning Models

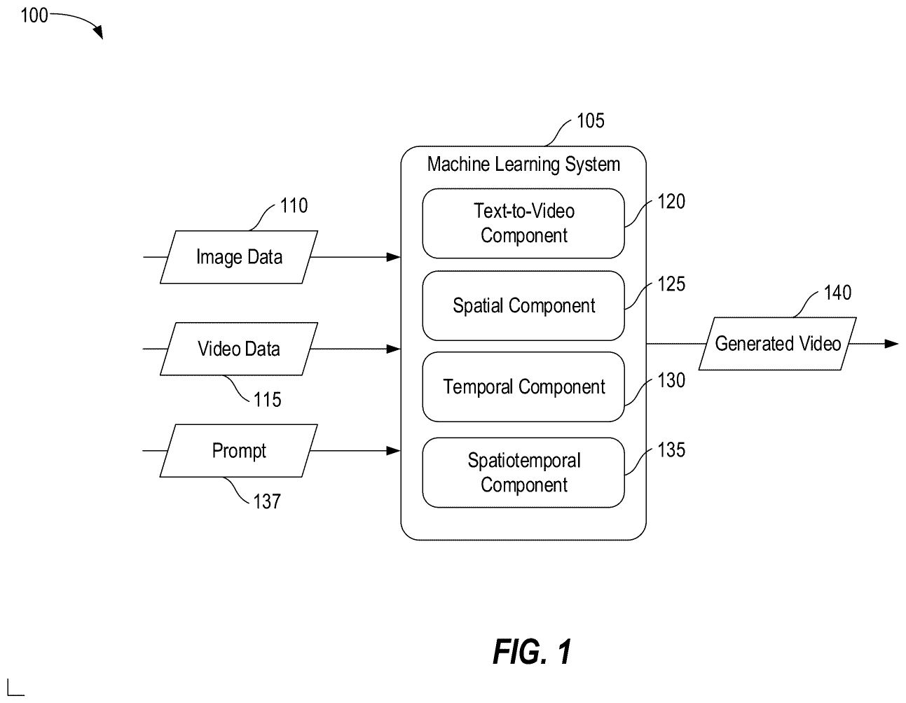

FIG. 1 depicts an example workflow 100 for video generation using machine learning models, according to some aspects of the present disclosure.

In the illustrated example, a machine learning system 105 accesses image data 110 and video data 115 to generate one or more generated videos 140. Although depicted as a single discrete system for conceptual clarity, in some aspects, the operations of the machine learning system 105 may be combined or distributed across any number and variety of systems. For example, in some aspects, a first computing system may be used to train or refine the model(s), while a second computing system may be used to generate video output using the trained models. As used herein, “accessing” data may generally include receiving, requesting, retrieving, obtaining, generating, collecting, or otherwise gaining access to the data. For example, the machine learning system 105 may receive the image data 110 and video data 115 from a user and/or a database or other repository (e.g., available via the Internet). In some aspects, the image data 110 may be provided to indicate the desired appearance of one or more objects in the generated video 140, while the video data 115 may be provided to indicate the desired motion of the object(s) in the generated video.

For example, in some aspects, the image data 110 may include one or more images of a man in a gorilla suit (along with a text prompt such as “a man in a gorilla suit”) to fine-tune the generation model based on the appearance of a man in a gorilla suit, as discussed in more detail below. Further, the video data 115 may include one or more videos (e.g., sequences of images) depicting a ballet dancer dancing (along with a text prompt such as “a ballet dancer is dancing”) to fine-tune the model based on the motion of the ballerina dancing, as discussed in more detail below. Subsequently, a text prompt 137 (such as “a man in a gorilla suit is a ballet dancer ballet dancing”) may be used as input, prompting the model to generate a generated video 140 depicting a man in a gorilla suit (with similar appearance to the man in the image data 110) performing ballet dancing (with similar motion to the dancer in the video data 115). Generally, the generated video 140 and the video data 115 each comprise a respective sequence of images (also referred to as frames in some aspects).

In the illustrated example, the machine learning system 105 includes a text-to-video component 120, a spatial component 125, a temporal component 130, and a spatiotemporal component 135. Although depicted as discrete components for conceptual clarity, the operations of the depicted components (and others not depicted) may be combined or distributed across any number of components, and may be implemented using hardware, software, or a combination of hardware and software. For example, in some aspects, the depicted components may each correspond to parameters of one or more machine learning models (which may in reality be merged or fused to form a single model, rather than a set of models).

In some aspects, the text-to-video component 120 corresponds to or comprises a generative machine learning model trained to generate video output based on textual prompts 137. For example, in some aspects, the text-to-video component 120 uses a pre-trained LDM. In some aspects, the text-to-video component 120 or model may be referred to as “pre-trained” to indicate that the model is trained during a training stage, and the parameters of the model are then frozen and unchanged while further components (e.g., LoRA adapters) are trained and refined to modify the output of the model. Although the illustrated example depicts a text-to-video component 120, in some aspects, other multi-modal models may be used (e.g., to generate audio, video, and/or image data).

In some aspects, the text-to-video component 120 uses a diffusion model (e.g., an LDM) that generates samples (e.g., video output) from noise (e.g., Gaussian noise) through a denoising process using text prompts. Generally, LDMs perform an iterative denoising process in the latent space of an autoencoder (rather than in the pixel domain). That is, in some aspects, the text-to-video component 120 can generate output videos by iteratively denoising noise conditioned based on an input text prompt 137 indicating the desired characteristics of the video (e.g., “a man in a gorilla suit dancing”).

In some aspects, as discussed above, the machine learning system 105 may train one or more additional model components to personalize the video generation based on the image data 110 and/or video data 115. For example, in the illustrated workflow 100, the machine learning system 105 may train the spatial component 125, temporal component 130, and/or spatiotemporal component 135 based on the image data 110 and video data 115.

In some aspects, to customize the text-to-video diffusion model (e.g., text-to-video component 120), the spatial component 125, temporal component 130, and spatiotemporal component 135 may each use low-rank adapters (e.g., LoRA adapters) for parameter-efficient fine-tuning (PEFT). For example, in some aspects, the text-to-video component 120 may include one or more spatial transformers (also referred to in some aspects as spatial attention blocks or components) and one or more temporal transformers (also referred to in some aspects as temporal attention blocks or components).

In the illustrated example, the spatial component 125 may correspond to one or more spatial LoRA(s) included in the spatial transformer(s) of the text-to-video component 120, and the temporal component 130 may correspond to one or more temporal LoRA(s) in the temporal transformer(s). In some aspects, the spatial component 125 may be trained using a single image (or a relatively small number of images) from the image data 110 based on a spatial loss, while the temporal component 130 may be trained based on the sequence of frames in the video data 115 using a temporal loss.

In some conventional solutions, text-to-video models may include spatial attention component(s) and temporal attention component(s) in a serial or sequential manner (e.g., where data is processed first by the spatial component(s) and then the temporal component(s), or vice versa). This can improve training efficiency and disentangle motion and appearance. However, as discussed above, when fine-tuning the model for a given set of video data 115, the motion customization capability of such conventional text-to-video generation models is inadequate. For example, reliance on spatial-only and temporal-only attention structures can, when serially composed, struggle to learn motion effectively.

In some aspects, as discussed above, the machine learning system 105 therefore uses a spatiotemporal component 135 to improve the model performance. Specifically, in some aspects, the spatiotemporal component 135 comprises or corresponds to one or more spatiotemporal attention blocks included with the personalized text-to-video model.

In some aspects, the spatiotemporal component 135 (e.g., the spatiotemporal attention blocks) can be added to the text-to-video model in a serial manner. However, in some aspects, such serial composition may risk deviating the feature output from the original value during fine-tuning, potentially leading to training instability. In some aspects, to improve training stability, the spatiotemporal component 135 uses a parallel approach based on a residual structure, where the spatiotemporal attention blocks may be arranged in parallel with the spatial component(s) 125 and/or temporal components 130, as discussed in more detail below.

Advantageously, by fine-tuning the spatiotemporal component 135 using the image data 110 and video data 115, the machine learning system 105 can substantially improve the accuracy and quality of the generated videos 140. For example, the generated video may be substantially more similar to the desired appearance (indicated using the image data 110) and the desired motion (indicated using the video data 115), as compared to conventional approaches.

### Example Attention Mechanisms for Generative Machine Learning

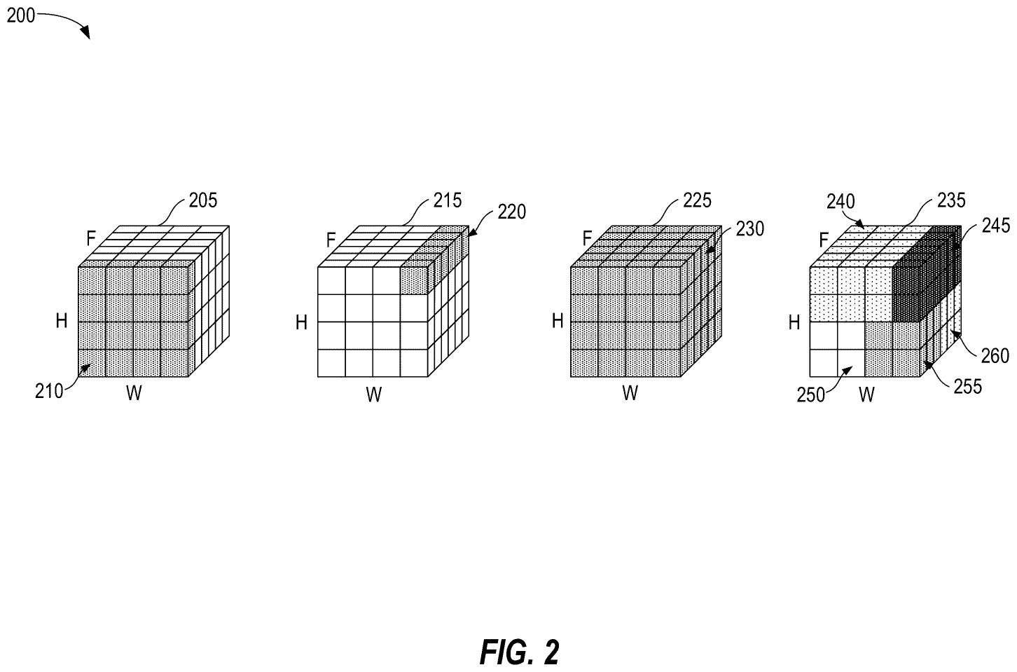

FIG. 2 depicts example attention mechanisms 200 for generative machine learning, according to some aspects of the present disclosure. In some aspects, the attention mechanisms 200 are used by a machine learning system, such as the machine learning system 105 of FIG. 1.

The illustrated attention mechanisms 200 indicate how attention is computed in various attention blocks of a text-to-video machine learning model (e.g., included in the text-to-video component 120 of FIG. 1). Specifically, in the illustrated example, block 205 illustrates spatial attention (e.g., used by the spatial component 125 of FIG. 1), block 215 illustrates temporal attention (e.g., used by the temporal component 130 of FIG. 1), and blocks 225 and 235 illustrate spatiotemporal attention (e.g., used by the spatiotemporal component 135 of FIG. 1).

As illustrated, each block 205, 215, 225, and 235 may comprise or correspond to a three-dimensional tensor of image/video data. Stated differently, each element of the illustrated blocks 205, 215, 225, and 235 (e.g., each cube, where the blocks 205, 215, 225, and 235 are each 4×4×6 cubes in size) may correspond to a pixel (or a transformed version of a pixel) from an image (e.g., in the image data 110 of FIG. 1 and/or the video data 115 of FIG. 1) in different frames. In some aspects, the blocks 205, 215, 225, and 235 may be referred to as transformed versions of image pixels to indicate that the data contained therein corresponds to or was generated based on pixels in one or more images. For example, the blocks 205, 215, 225, and 235 may be referred to as feature tensors or feature maps.

In the illustrated example, each block 205, 215, 225, and 235 is three dimensional with two spatial dimensions (denoted “H” and “W” in the illustrated example) and one depth dimension (denoted “F” in the illustrated example). Specifically, the spatial dimensions may correspond to the height and width of the tensors (e.g., four pixels tall by four pixels wide), and the depth dimension may correspond to the number of frames in the video input (e.g., six frames in the illustrated example).

As illustrated for the block 205, to perform a spatial attention (e.g., to generate a spatial version of the input image pixels), the machine learning system may generate, for each frame (e.g., for each index in the depth dimension), a respective self-attention value based on the spatial elements within the respective frame. That is, as illustrated by the portion 210 of the block 205, the spatial attention information may be generated across the entire frame (e.g., the spatial dimensions) for a single frame. Each respective frame may be processed separately to generate a corresponding spatial attention for the respective frame based on each other element in the same frame. Stated differently, the spatial attention may generate a respective spatial feature map having dimensionality [HW×HW] for each respective frame.

Further, as illustrated for the block 215, to perform a temporal attention (e.g., to generate a temporal version of the input image pixels), the machine learning system may generate, for each element or pixel in the block 215 (e.g., for each (h, w) index in the spatial dimensions), a respective self-attention value based on the corresponding spatial elements across multiple frames (e.g., across the depth dimension). That is, as illustrated by the portion 220 of the block 215, the temporal attention information may be generated for a given pixel location (e.g., a given spatial index) across a set of multiple frames (e.g., the depth dimension). Each respective pixel or spatial element may be processed separately to generate a corresponding temporal attention (across multiple frames) for the respective element based on the same pixels in each other frame. Stated differently, the temporal attention may generate a respective temporal feature map having dimensionality [F×F] for each respective pixel.

As illustrated for the block 225, to perform a spatiotemporal attention (e.g., to generate a spatiotemporal version of the input image pixels), the machine learning system may generate one or more self-attention values based on multiple spatial elements across multiple frames. That is, as illustrated by the portion 230 of the block 225 (which covers the entire block 225), the spatiotemporal attention information may be generated based on some or all pixel locations or spatial elements (e.g., multiple spatial indices) across a set of multiple frames (e.g., the depth dimension). Stated differently, the spatiotemporal attention may generate a spatiotemporal feature map having dimensionality [HWF×HWF].

In some aspects, a full spatiotemporal attention may be impractical or inefficient. For example, applying spatiotemporal attention across all pixels and all frames may consume a substantial number of operations (e.g., multiplications). Further, such full spatiotemporal attention may result in overfitting in some cases. In some aspects, the machine learning system computes spatiotemporal attention in tubelets, as illustrated by the block 235. As used herein, a “tubelet” generally corresponds to a set of one or more spatial elements or pixels (e.g., a true subset of the entire frame) across a set of the frames (e.g., a true subset of the total number of frames). For example, if each frame is four elements high and four elements wide, the tensor may be divided into four tubelets that are each two elements high and two elements wide. While the elements are divided evenly into tubelets in this example, the elements may be divided disproportionately into tubelets in other examples.

As illustrated for the block 235, the spatiotemporal attention may use tubelets such as illustrated by portion 240, portion 245, portion 250, portion 255, and/or portion 260. In the illustrated example, the portion 240 corresponds to a tubelet that is three elements wide, two elements tall, and six frames long. The portion 245 corresponds to a tubelet that is one clement wide, two elements tall, and six frames long. The portion 250 corresponds to a tubelet that is two elements wide and two elements tall (where the length of the tubelet is obscured by the block 235). The portion 255 corresponds to a tubelet that is two elements wide, two elements tall, and three frames long. The portion 260 corresponds to a tubelet that is similarly two elements tall, two elements wide, and three elements long.

Although the illustrated example depicts tubelets of varying size and dimensionality, in some aspects, the machine learning system may use a static set of tubelets (e.g., where all tubelets used to compute spatiotemporal attention stay the same size). As another example, in some aspects, the machine learning system may use dynamic tubelets (e.g., dynamically modifying or learning the tubelet heights, widths, and/or lengths during training). In some aspects, the tubelet-based spatiotemporal attention (e.g., attention within each tubelet) may be referred to as local spatiotemporal attention (as compared to full or global spatiotemporal attention illustrated by the block 225).

### Example Architectures for Generative Machine Learning

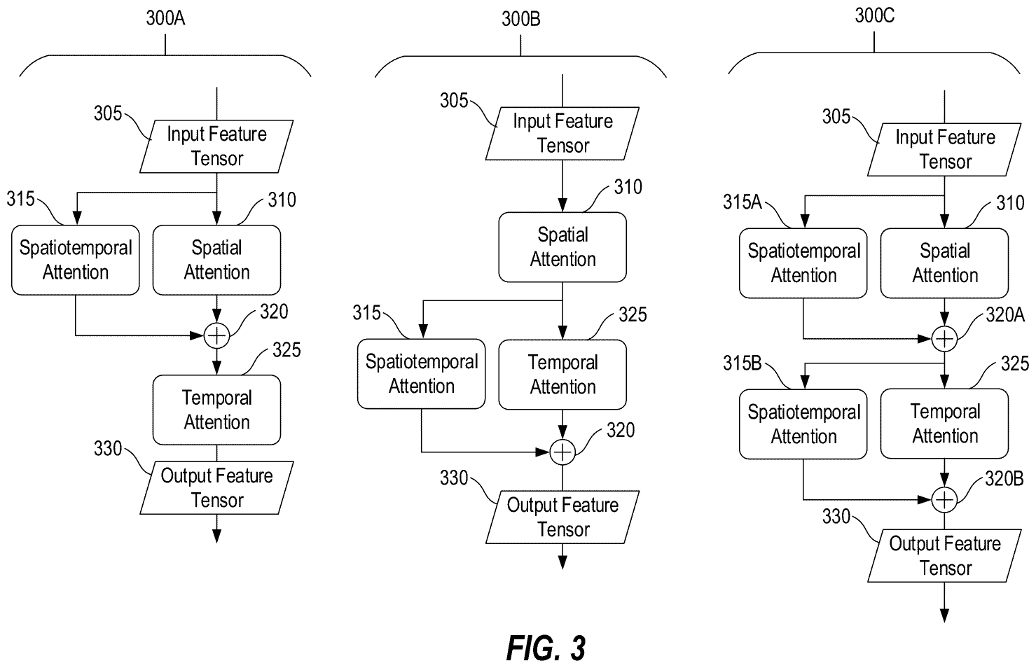

FIG. 3 depicts example architectures 300A-C (collectively, “architectures 300”) for generative machine learning, according to some aspects of the present disclosure. In some aspects, the architectures 300 are used by a machine learning system, such as the machine learning system 105 of FIG. 1 and/or the machine learning system discussed above with reference to FIG. 2. In some aspects, each architecture 300A, 300B, and 300C corresponds to a portion of a machine learning model, such as a text-to-video diffusion model (e.g., of the text-to-video component 120 of FIG. 1). In some aspects, each architecture 300 corresponds to one or more transformer blocks.

The architecture 300A depicts an example where spatiotemporal attention is used in parallel with spatial attention. Specifically, as illustrated, an input feature tensor 305 (e.g., a transformed version of image pixels) is accessed by a spatial attention block 310 (which may correspond to the spatial component 125 of FIG. 1, and may generate spatial attention as discussed above with reference to the block 205 of FIG. 2). The input feature tensor 305 is further accessed by a spatiotemporal attention block 315 (which may correspond to the spatiotemporal component 135 of FIG. 1, and may generate spatiotemporal attention as discussed above with reference to the blocks 225 and/or 235 of FIG. 2).

As illustrated, in the architecture 300A, the output of the spatiotemporal attention block 315 and the output of the spatial attention block 310 are then aggregated via an operation 320. Generally, the particular aggregation performed by the operation 320 may vary depending on the particular implementation. For example in some aspects, the operation 320 may comprise an elementwise addition. As illustrated, the aggregated tensor is then accessed by a temporal attention block 325 (which may correspond to the temporal component 130 of FIG. 1, and may generate temporal attention as discussed above with reference to the block 215 of FIG. 2).

As illustrated, the temporal attention block 325 outputs an output feature tensor 330 (also referred to in some aspects as an output version of the image pixels, or an output version of the feature tensor). This output feature tensor 330 serves as the transformer output for the architecture 300A.

The architecture 300B depicts an example where spatiotemporal attention is used in parallel with temporal attention. Specifically, as illustrated, the input feature tensor 305 is accessed by the spatial attention block 310 (which may correspond to the spatial component 125 of FIG. 1, and may generate spatial attention as discussed above with reference to the block 205 of FIG. 2). The output of the spatial attention block 310 is then accessed by a temporal attention block 325 (which may correspond to the temporal component 130 of FIG. 1, and may generate temporal attention as discussed above with reference to the block 215 of FIG. 2), as well as by the spatiotemporal attention block 315 (which may correspond to the spatiotemporal component 135 of FIG. 1, and may generate spatiotemporal attention as discussed above with reference to the blocks 225 and/or 235 of FIG. 2).

As illustrated, in the architecture 300B, the output of the spatiotemporal attention block 315 and the output of the temporal attention block 325 are then aggregated via an operation 320. Generally, the particular aggregation performed by the operation 320 may vary depending on the particular implementation. For example in some aspects, the operation 320 may comprise an elementwise addition. As illustrated, the aggregated tensor is then used as the output feature tensor 330 for the architecture 300B.

The architecture 300C depicts an example where spatiotemporal attention is used in parallel with both the spatial attention and the temporal attention. Specifically, as illustrated, the input feature tensor 305 is accessed by the spatial attention block 310 (which may correspond to the spatial component 125 of FIG. 1, and may generate spatial attention as discussed above with reference to the block 205 of FIG. 2) as well as by a first spatiotemporal attention block 315A (which may correspond to the spatiotemporal component 135 of FIG. 1, and may generate spatiotemporal attention as discussed above with reference to the blocks 225 and/or 235 of FIG. 2).

The output of the spatiotemporal attention block 315A and the output of the spatial attention block 310 are then aggregated via an operation 320A (e.g., elementwise addition). The aggregated tensor (output by the operation 320A) is then accessed by the temporal attention block 325 (which may correspond to the temporal component 130 of FIG. 1, and may generate temporal attention as discussed above with reference to the block 215 of FIG. 2), as well as by a second spatiotemporal attention block 315B (which may correspond to the spatiotemporal component 135 of FIG. 1, and may generate spatiotemporal attention as discussed above with reference to the blocks 225 and/or 235 of FIG. 2).

As illustrated, in the architecture 300C, the output of the spatiotemporal attention block 315B and the output of the temporal attention block 325 are then aggregated via an operation 320B (e.g., elementwise addition) to generate an output feature tensor 330 for the architecture 300C.

Although the depicted architectures 300A-C each depict the spatial attention block 310 being performed prior to the temporal attention block 325, in some aspects, the temporal attention block 325 may be computed prior to the spatial attention block 310, depending on the particular implementation.

Generally, the output feature tensor 330 for each architecture 300A-C may be provided to any downstream processing in order to generate mode output. For example, the output feature tensor 330 may be used as input to a subsequent transformer or other component of the text-to-video model. That is, the final output of the model (e.g., the generated video 140 of FIG. 1) (also referred to in some aspects as a set of output image pixels) may be generated based at least in part on the output feature tensor 330.

### Example Architecture for Spatiotemporal Attention in Generative Machine Learning Models

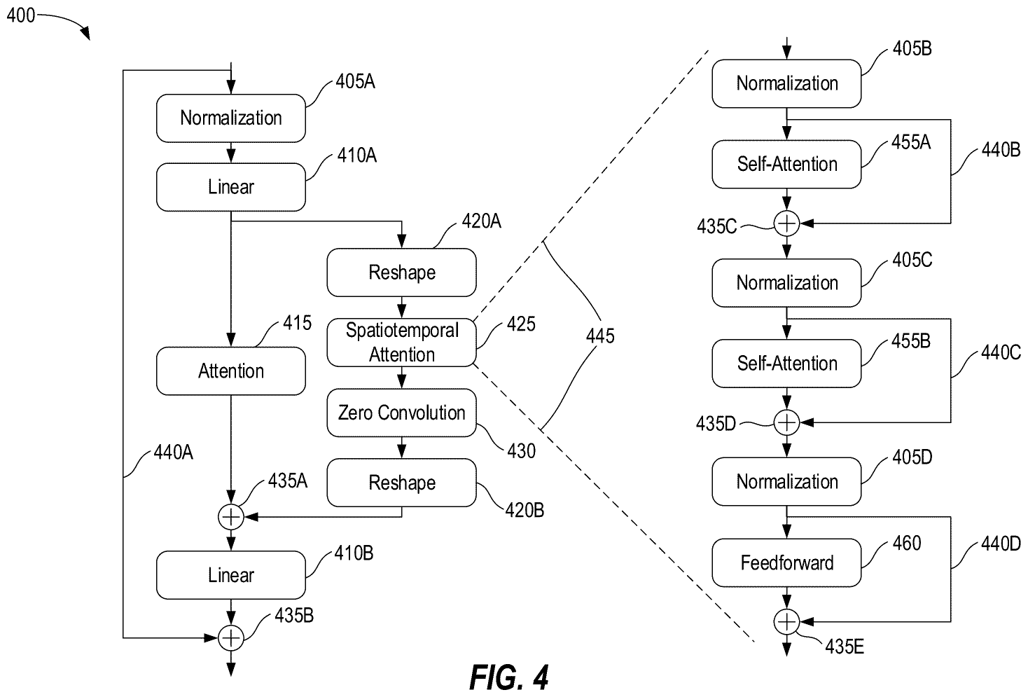

FIG. 4 depicts an example architecture 400 for spatiotemporal attention in generative machine learning models, according to some aspects of the present disclosure. In some aspects, the architecture 400 is used by a machine learning system, such as the machine learning system 105 of FIG. 1 and/or the machine learning system discussed above with reference to FIGS. 2-3.

In some aspects, the architecture 400 corresponds to a spatiotemporal attention block (e.g., the spatiotemporal attention block 315 of FIG. 3) and a corresponding spatial attention block (e.g., the spatial attention block 310 of FIG. 3) or temporal attention block (e.g., the temporal attention block 325 of FIG. 3). For example, the blocks 405A, 410A, 415, and 410B as well as the operations 435A and/or 435B may be part of a spatial attention block (if the attention block 415 corresponds to spatial attention) or a temporal attention block (if the attention block 415 corresponds to temporal attention). Similarly, the blocks 420A, 425, 430, and 420B may be part of the spatiotemporal block.

In the illustrated architecture 400, the input feature tensor (e.g., a transformed version of image pixels) is accessed by a normalization block 405A which applies one or more normalization operations to the input features. In some aspects, the block 405A performs a group normalization operation. In some aspects, the group normalization includes dividing channels (e.g., frames) into groups, and normalizes the features within each group.

The output of the normalization block 405A is accessed by a linear block 410A which applies one or more linear operations or transformations. For example, in some aspects, the linear block 410A may perform a linear projection to prepare the features for input to the attention block 415. For example, in some aspects, the linear block 410A applies a set of learned weights to the input features.

As illustrated, the output of the linear block 410A is then accessed by an attention block 415. Further, in parallel, the output of the linear block 410A is accessed by a reshape block 420A. The attention block 415 may generally correspond to spatial attention or temporal attention, as discussed above. The output of the attention block 415 is provided to an operation 435A, discussed in more detail below.

The reshape block 420A is generally used to reshape the input tensor to prepare for spatiotemporal attention. For example, in some aspects, the tensor output by the linear block 410A may have shape [bHW, F, d] where b is the batch size, F is the number of frames in the sequence, H and W are spatial dimensions (e.g., height and width, respectively), and d is the dimensionality or depth of each individual frame or image (e.g., where a red, green, and blue (RGB) image may have d=3). In some aspects, the reshape block 420A reshapes the input to a tensor of shape [b, HWF, d].

As illustrated, the reshaped tensor is then processed by a spatiotemporal block 425 to generate spatiotemporal attention. As illustrated by the lines 445, the spatiotemporal block 425 comprises a sequence of operations discussed in more detail below.

In the depicted architecture 400, the output of the spatiotemporal block 425 is processed using a zero convolution block 430. In some aspects, the zero convolution block 430 corresponds to a convolution operation that was initialized with parameters having a value of zero (e.g., as compared to initializing with random values), which can help preserve the performance of any pre-trained components, such as the attention block 415. These parameters may be learned during training of the spatiotemporal attention.

The output of the zero convolution block 430 is then processed by a second reshape block 420B to reshape the output. For example, in some aspects, the reshape block 420B may transform the output of the zero convolution block 430 from shape [b, HWF, d] to shape [b, F, d]. This reshaped output from the spatiotemporal attention is then provided to the operation 435A.

The operation 435A may generally aggregate the output of the attention block 415 and the output of the reshape block 420B, such as using elementwise addition. As illustrated, the aggregated tensor is then processed by another linear block 410B (e.g., another linear projection), and the resulting tensor is aggregated with the original input tensor (the feature tensor provided as input to the normalization block 405A), accessed via the residual 440A, using the operation 435B (e.g., elementwise addition). As discussed above, the output feature tensor may then be provided to any downstream components to generate the output of the machine learning model.

As discussed above, the spatiotemporal block 425 may include a variety of operations. In the illustrated example, as depicted by the lines 445, the spatiotemporal block 425 first includes a normalization block 405B. For example, the normalization block 405B may perform a layer normalization operation. The normalized tensor is then processed by a self-attention block 455A to generate an attention tensor. Although not depicted in the illustrated example, in some aspects, the self-attention block 455A may generally include generating queries (Q), keys (K), and values (V) based on multiplying some or all of the input tensor using learned parameters, and combining the queries, keys, and values to generate an output attention tensor. For example, as discussed above, the self-attention block 455A may generate the attention based on a set of multiple spatial elements across multiple frames (e.g., the full spatiotemporal attention discussed above with reference to the block 225 of FIG. 2 and/or the local spatiotemporal attention discussed above with reference to the block 235 of FIG. 2).

As illustrated, the output of the self-attention block 455A is then aggregated with the output of the normalization block 405B (via the residual 440B) using operation 435C (e.g., elementwise addition). The output of the operation 435C is then provided to a second normalization block 405C (e.g., another layer normalization operation). The normalized tensor is then processed by a second self-attention block 455B to generate a second attention tensor.

As illustrated, the output of the self-attention block 455B is then aggregated with the output of the normalization block 405C (via the residual 440C) using operation 435D (e.g., elementwise addition). The output of the operation 435D is then provided to a third normalization block 405D (e.g., another layer normalization operation).

The output of the normalization block 405D is then processed by a feedforward block 460. The feedforward block 460 generally corresponds to one or more layers (e.g., of a neural network) having trained parameters to transform the input tensor. For example, in some aspects, the feedforward block 460 includes a gated linear unit (GLU) with generalized linear unit (GELU) activations (e.g., a GeGLU block) followed by a linear projection.

In the illustrated example, the output of the feedforward block 460 is then aggregated with the input to the feedforward block 460 (via the residual 440D) using the operation 435E (e.g., elementwise addition).

In some aspects, the attention block 415 may include the same or similar components as the spatiotemporal block 425 (with different sets of pixels used to generate the attention). For example, as discussed above, the attention block 415 may include self-attention based on a different set of elements (e.g., across spatial elements within each frame for spatial attention as discussed above with reference to the block 205 of FIG. 2 or for each spatial element across multiple frames for temporal attention as discussed above with reference to the block 215 of FIG. 2).

As discussed above, some or all of the components in the architecture 400 may use or include LoRA adapters which are trained during the fine-tuning of the model based on personalized input data (e.g., based on the image data 110 and/or the video data 115, each of FIG. 1). For example, in the illustrated architecture 400, LoRA adapters may be injected into one or more components of the self-attention blocks 455A-B (e.g., for the parameters used to compute the queries, keys, and values), into one or more components of the feedforward block 460 (e.g., for the GeGLU block and the linear projection), and/or into the zero convolution block 430. By fine-tuning these LoRA adapters, the machine learning system can substantially improve the performance and accuracy of the model.

### Example Method for Training Spatiotemporal Attention Components for Generative Machine Learning

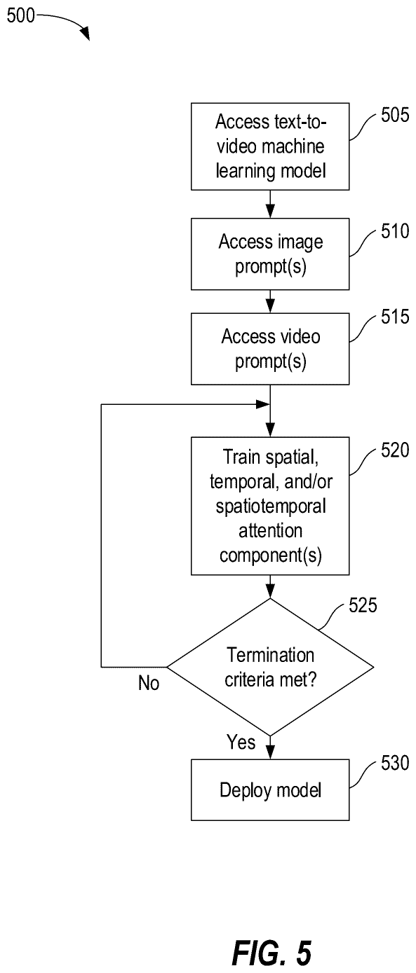

FIG. 5 is a flow diagram depicting an example method 500 for training spatiotemporal attention components for generative machine learning, according to some aspects of the present disclosure. In some aspects, the method 500 is performed by a machine learning system, such as the machine learning system 105 of FIG. 1 and/or the machine learning system discussed above with reference to FIGS. 2-4.

At block 505, the machine learning system accesses a text-to-video machine learning model (or other multi-modal model). For example, as discussed above, the machine learning system may access a pre-trained LDM that is trained to generate output videos based on input textual prompts describing the desired output.

At block 510, the machine learning system accesses a set of one or more image prompts (e.g., the image data 110 of FIG. 1) used to indicate the desired spatial appearance(s) for the output video. For example, as discussed above, the image prompts may depict a man wearing a gorilla suit, along with text such as “the man is in a gorilla suit.”

At block 515, the machine learning system accesses a set of one or more video prompts (e.g., the video data 115 of FIG. 1) used to indicate the desired motion of the output video. For example, as discussed above, the video prompts may depict a ballerina dancing, along with text such as “the ballerina is dancing.” In some aspects, the image prompts and/or video prompts may be captured via a camera coupled to the machine learning system.

At block 520, the machine learning system trains one or more spatial attention components (e.g., the spatial component 125 of FIG. 1, the spatial attention block 310 of FIG. 3, and/or the attention block 415 of FIG. 4), one or more temporal attention components (e.g., the temporal component 130 of FIG. 1, the temporal attention block 325 of FIG. 3, and/or the attention block 415 of FIG. 4), and/or one or more spatiotemporal attention components based on the image prompt(s) and video prompt(s) (e.g., the spatiotemporal component 135 of FIG. 1, the spatiotemporal attention block 315 of FIG. 3, and/or the spatiotemporal block 425 of FIG. 4).

In some aspects, as discussed above, training these components comprises updating one or more parameters of the model (e.g., LoRA adapters for these attention blocks) while keeping one or more other parameters (e.g., the remaining parameters of the text-to-video machine learning model) frozen.

At block 525, the machine learning system determines whether one or more training termination criteria have been met. Generally, the termination criteria may vary depending on the particular implementation, and may include determining whether any additional input prompts are available for training, whether a defined number of iterations or amount of time has been spent training, and the like. If, at block 525, the machine learning system determines that the termination criteria are not satisfied, the method 500 returns to block 520 to continue training.

If, at block 525, the machine learning system determines that the termination criteria are met, the method 500 continues to block 530, where the machine learning system deploys the aggregate model (e.g., the base text-to-video model, as well as the trained adapter(s), such as a spatiotemporal attention block) for runtime use. As used herein, “deploying” the model may generally include a variety of operations to prepare or provide the model for video generation, including merging or fusing the adapter parameters with the base model, transmitting the parameters to a second system for runtime use, instantiating the model locally for runtime use, and the like.

### Example Method for Generating Video Output Using Spatiotemporal Attention

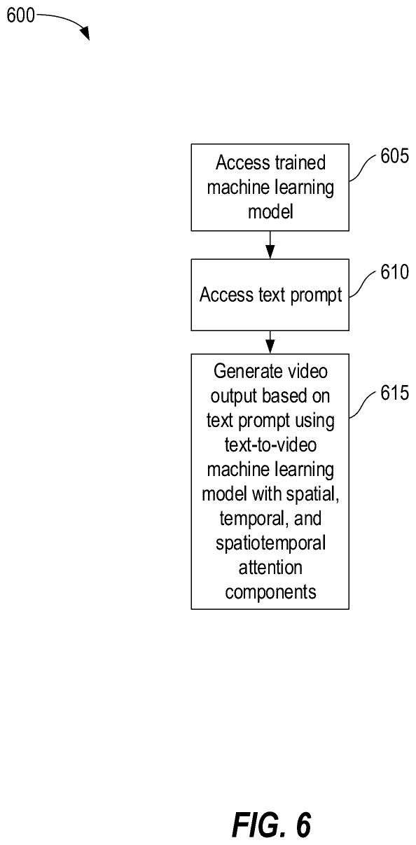

FIG. 6 is a flow diagram depicting an example method 600 for generating video output using spatiotemporal attention, according to some aspects of the present disclosure. In some aspects, the method 600 is performed by a machine learning system, such as the machine learning system 105 of FIG. 1 and/or the machine learning system discussed above with reference to FIGS. 2-5.

At block 605, the machine learning system accesses a trained machine learning model (e.g., an aggregated model including a base text-to-video model and a set of fine-tuned adapters, as discussed above). For example, the model may have been trained (by the machine learning system, or by another system) using the method 500 of FIG. 5.

At block 610, the machine learning system accesses a text prompt to be used to generate the output video. For example, as discussed above, the prompt may include natural language text. In some aspects, the prompt may be a combination of the text prompt(s) used to train the model based on image data coupled with the text prompt(s) used to train the model based on video data. For example, the input prompt may include “a man in a gorilla suit is doing ballerina dancing.”

At block 615, the machine learning system generates a video output (also referred to as a set of output pixels in some aspects) based on processing the input using a text-to-video model that includes spatial, temporal, and spatiotemporal attention components, as discussed above.

Although not included in the illustrated example, in some aspects, the generated video may then be displayed (e.g., via a display coupled to the machine learning system).

### Example Method for Spatiotemporal Attention

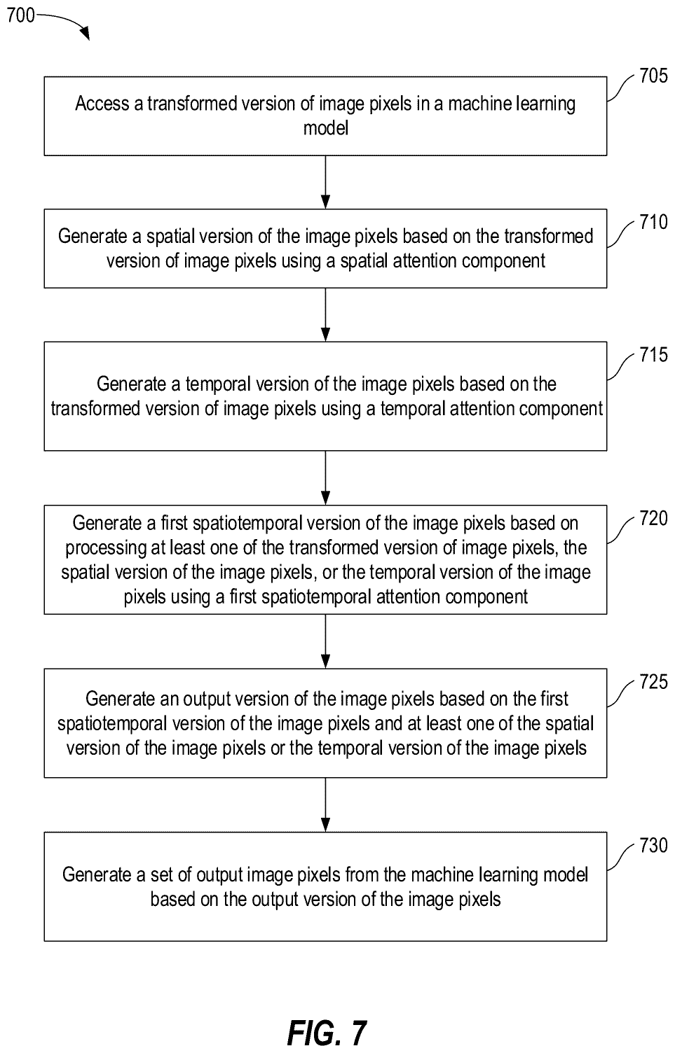

FIG. 7 is a flow diagram depicting an example method 700 for spatiotemporal attention, according to some aspects of the present disclosure. In some aspects, the method 700 is performed by a machine learning system, such as the machine learning system 105 of FIG. 1 and/or the machine learning system discussed above with reference to FIGS. 2-6.

At block 705, a transformed version of image pixels is accessed in a machine learning model trained to provide controllability of generated videos.

At block 710, a spatial version of the image pixels is generated based on the transformed version of image pixels using a spatial attention component.

At block 715, a temporal version of the image pixels is generated based on the transformed version of image pixels using a temporal attention component.

At block 720, a first spatiotemporal version of the image pixels is generated based on processing at least one of the transformed version of image pixels, the spatial version of the image pixels, or the temporal version of the image pixels using a first spatiotemporal attention component.

At block 725, an output version of the image pixels is generated based on the first spatiotemporal version of the image pixels and at least one of the spatial version of the image pixels or the temporal version of the image pixels.

At block 730, a set of output image pixels from the machine learning model is generated based on the output version of the image pixels, wherein the set of output image pixels portray motion depicted in prompt video data for the machine learning model.

In some aspects, generating the first spatiotemporal version of the image pixels comprises processing the spatial version of the image pixels using the first spatiotemporal attention component, generating the temporal version of the image pixels comprises processing the spatial version of the image pixels using the temporal attention component, and generating the output version of the image pixels comprises aggregating the first spatiotemporal version of the image pixels and the temporal version of the image pixels.

In some aspects, generating the first spatiotemporal version of the image pixels comprises processing the transformed version of image pixels using the first spatiotemporal attention component, and generating the temporal version of the image pixels comprises generating an aggregated version of the image pixels by aggregating the first spatiotemporal version of the image pixels and the spatial version of the image pixels and processing the aggregated version of the image pixels using the temporal attention component.

In some aspects, the method 700 further includes generating a second spatiotemporal version of the image pixels based on processing the aggregated version of the image pixels using a second spatiotemporal attention component, wherein generating the output version of the image pixels comprises aggregating the second spatiotemporal version of the image pixels and the temporal version of the image pixels.

In some aspects, generating the spatial version of the image pixels comprises generating, for each respective frame of the transformed version of image pixels, a respective spatial self-attention value based on a respective plurality of spatial elements in the respective frame, generating the temporal version of the image pixels comprises generating, for each respective spatial element of a version of the image pixels input for the temporal attention component, a respective temporal self-attention value based on a respective plurality of frames of the version of the image pixels input for the temporal attention component, and generating the first spatiotemporal version of the image pixels comprises generating at least one spatiotemporal self-attention value based on a plurality of spatial elements and a plurality of frames of a version of the image pixels input for the first spatiotemporal attention component.

In some aspects, generating the first spatiotemporal version of the image pixels comprises generating a plurality of self-attention values, each respective self-attention value of the plurality of self-attention values being generated based on a respective tubelet of a plurality of tubelets in the version of the image pixels input for the first spatiotemporal attention component.

In some aspects, each respective tubelet of the plurality of tubelets comprises at least two spatial elements of the plurality of spatial elements across at least two frames of the plurality of frames of the version of the image pixels input for the first spatiotemporal attention component.

In some aspects, a respective size of each respective tubelet of the plurality of tubelets was learned during training of the first spatiotemporal attention component.

In some aspects, the machine learning model comprises a text-to-video machine learning model.

In some aspects, the method 700 further includes capturing a set of image pixels that are transformed to generate the transformed version of image pixels using a camera.

In some aspects, the method 700 further includes displaying the set of output image pixels using a display.

### Example Processing System for Machine Learning

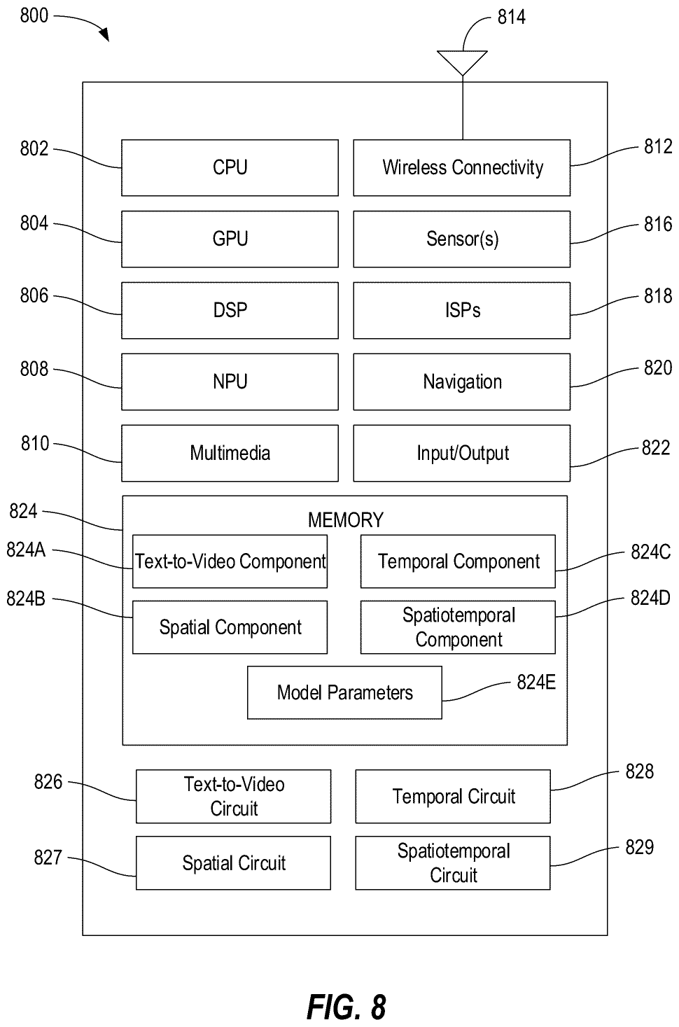

FIG. 8 depicts an example processing system 800 configured to perform various aspects of the present disclosure, including, for example, the techniques and methods described with respect to FIGS. 1-7. In some aspects, the processing system 800 may correspond to a machine learning system. For example, the processing system 800 may correspond to the machine learning system discussed above with reference to FIGS. 1-7. Although depicted as a single system for conceptual clarity, in some aspects, as discussed above, the components described below with respect to the processing system 800 may be distributed across any number of devices or systems.

The processing system 800 includes a central processing unit (CPU) 802, which in some examples may be a multi-core CPU. Instructions executed at the CPU 802 may be loaded, for example, from a program memory associated with the CPU 802 or may be loaded from a memory partition (e.g., a partition of a memory 824).

The processing system 800 also includes additional processing components tailored to specific functions, such as a graphics processing unit (GPU) 804, a digital signal processor (DSP) 806, a neural processing unit (NPU) 808, a multimedia component 810 (e.g., a multimedia processing unit), and a wireless connectivity component 812.

An NPU, such as the NPU 808, is generally a specialized circuit configured for implementing the control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 808, are configured to accelerate the performance of common machine learning tasks, such as image classification, machine translation, object detection, and various other predictive models. In some examples, a plurality of NPUs may be instantiated on a single chip, such as a system on a chip (SoC), while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this piece of data through an already trained model to generate a model output (e.g., an inference).

In some implementations, the NPU 808 is a part of one or more of the CPU 802, the GPU 804, and/or the DSP 806.

In some examples, the wireless connectivity component 812 may include subcomponents, for example, for third generation (3G) connectivity, fourth generation (4G) connectivity (e.g., Long-Term Evolution (LTE)), fifth generation (5G) connectivity (e.g., New Radio (NR)), Wi-Fi connectivity, Bluetooth connectivity, and other wireless data transmission standards. The wireless connectivity component 812 is further coupled to one or more antennas 814.

The processing system 800 may also include one or more sensor processing units 816 associated with any manner of sensor, one or more image signal processors (ISPs) 818 associated with any manner of image sensor, and/or a navigation processor 820, which may include satellite-based positioning system components (e.g., GPS or GLONASS) as well as inertial positioning system components.

The processing system 800 may also include one or more input and/or output devices 822, such as screens, touch-sensitive surfaces (including touch-sensitive displays), physical buttons, speakers, microphones, and the like.

In some examples, one or more of the processors of the processing system 800 may be based on an ARM or RISC-V instruction set.

The processing system 800 also includes a memory 824, which is representative of one or more static and/or dynamic memories, such as a dynamic random access memory, a flash-based static memory, and the like. In this example, the memory 824 includes computer-executable components, which may be executed by one or more of the aforementioned processors of the processing system 800.

In particular, in this example, the memory 824 includes a text-to-video component 824A, a spatial component 824B, a temporal component 824C, and a spatiotemporal component 824D. Although not depicted in the illustrated example, the memory 824 may also include other components, such as an inferencing or generation component to manage the generation of output videos using trained machine learning models, a training component used to train or update the machine learning model(s), and the like. Though depicted as discrete components for conceptual clarity in FIG. 8, the illustrated components (and others not depicted) may be collectively or individually implemented in various aspects.

As illustrated, the memory 824 also includes a set of model parameters 824E (e.g., parameters of one or more machine learning models, such as weights and/or biases, used to generate model output). For example, as discussed above, the model parameters 824E may include pre-trained parameters for a base text-to-video model, learned parameters for one or more adapters (e.g., spatial components, temporal components, and spatiotemporal components), and the like. Although not depicted in the illustrated example, the memory 824 may also include other data such as training data.

The processing system 800 further comprises a text-to-video circuit 826, a spatial circuit 827, a temporal circuit 828, and a spatiotemporal circuit 829. The depicted circuits, and others not depicted (such as an inferencing circuit), may be configured to perform various aspects of the techniques described herein.

The text-to-video component 824A and/or the text-to-video circuit 826 (which may correspond to the text-to-video component 120 of FIG. 1) may be used to generate video output using a pre-trained machine learning model, as discussed above. For example, the text-to-video component 824A and/or the text-to-video circuit 826 may generate output data based on processing input text prompts using the pre-trained model(s).

The spatial component 824B and/or the spatial circuit 827 (which may correspond to the spatial component 125 of FIG. 1, the spatial attention block 310 of FIG. 3, and/or the attention block 415 of FIG. 4) may be used to apply spatial attention operations, as discussed above. For example, the spatial component 824B and/or the spatial circuit 827 may use attention such as described with reference to the block 205 of FIG. 2 to generate attention values for each video frame.

The temporal component 824C and/or the temporal circuit 828 (which may correspond to the temporal component 130 of FIG. 1, the temporal attention block 325 of FIG. 3, and/or the attention block 415 of FIG. 4) may be used to apply temporal attention operations, as discussed above. For example, the temporal component 824C and/or the temporal circuit 828 may use attention such as described with reference to the block 215 of FIG. 2 to generate attention values for each spatial element across frames.

The spatiotemporal component 824D and/or the spatiotemporal circuit 829 (which may correspond to the spatiotemporal component 135 of FIG. 1, the spatiotemporal attention block 315 of FIG. 3, and/or the spatiotemporal block 425 of FIG. 4) may be used to apply spatiotemporal attention operations, as discussed above. For example, the spatiotemporal component 824D and/or the spatiotemporal circuit 829 may use attention such as described with reference to the blocks 225 and/or 235 of FIG. 2 to generate attention values for each set of spatial elements across a set of frames.

Though depicted as separate components and circuits for clarity in FIG. 8, the text-to-video circuit 826, the spatial circuit 827, the temporal circuit 828, and the spatiotemporal circuit 829 may collectively or individually be implemented in other processing devices of the processing system 800, such as within the CPU 802, the GPU 804, the DSP 806, the NPU 808, and the like.

Generally, the processing system 800 and/or components thereof may be configured to perform the methods described herein.

Notably, in other aspects, aspects of the processing system 800 may be omitted, such as where the processing system 800 is a server computer or the like. For example, the multimedia component 810, the wireless connectivity component 812, the sensor processing units 816, the ISPs 818, and/or the navigation processor 820 may be omitted in other aspects. Further, aspects of the processing system 800 maybe distributed between multiple devices.

### Example Clauses

Implementation examples are described in the following numbered clauses:

Clause 1: A method, comprising: accessing a transformed version of image pixels in a machine learning model trained to provide controllability of generated videos; generating a spatial version of the image pixels based on the transformed version of image pixels using a spatial attention component; generating a temporal version of the image pixels based on the transformed version of image pixels using a temporal attention component; generating a first spatiotemporal version of the image pixels based on processing at least one of the transformed version of image pixels, the spatial version of the image pixels, or the temporal version of the image pixels using a first spatiotemporal attention component; generating an output version of the image pixels based on the first spatiotemporal version of the image pixels and at least one of the spatial version of the image pixels or the temporal version of the image pixels; and generating a set of output image pixels from the machine learning model based on the output version of the image pixels, wherein the set of output image pixels portray motion depicted in prompt video data for the machine learning model.

Clause 2: A method according to Clause 1, wherein: generating the first spatiotemporal version of the image pixels comprises processing the spatial version of the image pixels using the first spatiotemporal attention component, generating the temporal version of the image pixels comprises processing the spatial version of the image pixels using the temporal attention component, and generating the output version of the image pixels comprises aggregating the first spatiotemporal version of the image pixels and the temporal version of the image pixels.

Clause 3: A method according to Clause 1, wherein: generating the first spatiotemporal version of the image pixels comprises processing the transformed version of image pixels using the first spatiotemporal attention component, and generating the temporal version of the image pixels comprises: generating an aggregated version of the image pixels by aggregating the first spatiotemporal version of the image pixels and the spatial version of the image pixels; and processing the aggregated version of the image pixels using the temporal attention component.

Clause 4: A method according to Clause 3, further comprising generating a second spatiotemporal version of the image pixels based on processing the aggregated version of the image pixels using a second spatiotemporal attention component, wherein generating the output version of the image pixels comprises aggregating the second spatiotemporal version of the image pixels and the temporal version of the image pixels.

Clause 5: A method according to any of Clauses 1-4, wherein: generating the spatial version of the image pixels comprises generating, for each respective frame of the transformed version of image pixels, a respective spatial self-attention value based on a respective plurality of spatial elements in the respective frame; generating the temporal version of the image pixels comprises generating, for each respective spatial element of a version of the image pixels input for the temporal attention component, a respective temporal self-attention value based on a respective plurality of frames of the version of the image pixels input for the temporal attention component; and generating the first spatiotemporal version of the image pixels comprises generating at least one spatiotemporal self-attention value based on a plurality of spatial elements and a plurality of frames of a version of the image pixels input for the first spatiotemporal attention component.

Clause 6: A method according to Clause 5, wherein generating the first spatiotemporal version of the image pixels comprises generating a plurality of self-attention values, each respective self-attention value of the plurality of self-attention values being generated based on a respective tubelet of a plurality of tubelets in the version of the image pixels input for the first spatiotemporal attention component.

Clause 7: A method according to Clause 6, wherein each respective tubelet of the plurality of tubelets comprises at least two spatial elements of the plurality of spatial elements across at least two frames of the plurality of frames of the version of the image pixels input for the first spatiotemporal attention component.

Clause 8: A method according to any of Clauses 6-7, wherein a respective size of each respective tubelet of the plurality of tubelets was learned during training of the first spatiotemporal attention component.

Clause 9: A method according to any of Clauses 1-8, wherein the machine learning model comprises a text-to-video machine learning model.

Clause 10: A method according to any of Clauses 1-8, further comprising capturing a set of image pixels that are transformed to generate the transformed version of image pixels using a camera.

Clause 11: A method according to any of Clauses 1-9, further comprising displaying the set of output image pixels using a display.

Clause 12: A processing system comprising: a memory comprising computer-executable instructions; and one or more processors configured to execute the computer-executable instructions and cause the processing system to perform a method in accordance with any of Clauses 1-11.

Clause 13: A processing system comprising means for performing a method in accordance with any of Clauses 1-11.

Clause 14: A non-transitory computer-readable medium comprising computer-executable instructions that, when executed by one or more processors of a processing system, cause the processing system to perform a method in accordance with any of Clauses 1-11.

Clause 15: A computer program product embodied on a computer-readable storage medium comprising code for performing a method in accordance with any of Clauses 1-11.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processing system in a device, comprising:
a memory configured to store machine learning model parameters; and
one or more processors, coupled to the memory, configured to:
access a transformed version of image pixels in a machine learning model trained to provide controllability of generated videos;
generate a spatial version of the image pixels based on the transformed version of image pixels using a spatial attention component;
generate a temporal version of the image pixels based on the transformed version of image pixels using a temporal attention component;
generate a first spatiotemporal version of the image pixels based on processing at least one of the transformed version of image pixels, the spatial version of the image pixels, or the temporal version of the image pixels using a first spatiotemporal attention component;
generate an output version of the image pixels based on the first spatiotemporal version of the image pixels and at least one of the spatial version of the image pixels or the temporal version of the image pixels; and
generate a set of output image pixels from the machine learning model based on the output version of the image pixels, wherein the set of output image pixels portray motion depicted in prompt video data for the machine learning model.

2. The processing system of claim 1, wherein:
to generate the first spatiotemporal version of the image pixels, the one or more processors are configured to process the spatial version of the image pixels using the first spatiotemporal attention component;
to generate the temporal version of the image pixels, the one or more processors are configured to process the spatial version of the image pixels using the temporal attention component; and
to generate the output version of the image pixels, the one or more processors are configured to aggregate the first spatiotemporal version of the image pixels and the temporal version of the image pixels.

3. The processing system of claim 1, wherein:
to generate the first spatiotemporal version of the image pixels, the one or more processors are configured to process the transformed version of image pixels using the first spatiotemporal attention component; and
to generate the temporal version of the image pixels, the one or more processors are configured to:
generate an aggregated version of the image pixels by aggregating the first spatiotemporal version of the image pixels and the spatial version of the image pixels; and
process the aggregated version of the image pixels using the temporal attention component.

4. The processing system of claim 3, wherein:
the one or more processors are configured to generate a second spatiotemporal version of the image pixels based on processing the aggregated version of the image pixels using a second spatiotemporal attention component; and
to generate the output version of the image pixels, the one or more processors are configured to aggregate the second spatiotemporal version of the image pixels and the temporal version of the image pixels.

5. The processing system of claim 1, wherein:
to generate the spatial version of the image pixels, the one or more processors are configured to generate, for each respective frame of the transformed version of image pixels, a respective spatial self-attention value based on a respective plurality of spatial elements in the respective frame;
to generate the temporal version of the image pixels, the one or more processors are configured to generate, for each respective spatial element of a version of the image pixels input for the temporal attention component, a respective temporal self-attention value based on a respective plurality of frames of the version of the image pixels input for the temporal attention component; and
to generate the first spatiotemporal version of the image pixels, the one or more processors are configured to generate at least one spatiotemporal self-attention value based on a plurality of spatial elements and a plurality of frames of a version of the image pixels input for the first spatiotemporal attention component.

6. The processing system of claim 5, wherein, to generate the first spatiotemporal version of the image pixels, the one or more processors are configured to generate a plurality of self-attention values, each respective self-attention value of the plurality of self-attention values being generated based on a respective tubelet of a plurality of tubelets in the version of the image pixels input for the first spatiotemporal attention component.

7. The processing system of claim 6, wherein each respective tubelet of the plurality of tubelets comprises at least two spatial elements of the plurality of spatial elements across at least two frames of the plurality of frames of the version of the image pixels input for the first spatiotemporal attention component.

8. The processing system of claim 6, wherein a respective size of each respective tubelet of the plurality of tubelets was learned during training of the first spatiotemporal attention component.

9. The processing system of claim 1, wherein the machine learning model comprises a text-to-video machine learning model.

10. The processing system of claim 1, further comprising a camera configured to capture a set of image pixels that are transformed to generate the transformed version of image pixels.

11. The processing system of claim 1, further comprising a display configured to display the set of output image pixels.

12. A processor-implemented method for generative machine learning, comprising:
accessing a transformed version of image pixels in a machine learning model trained to provide controllability of generated videos;
generating a spatial version of the image pixels based on the transformed version of image pixels using a spatial attention component;
generating a temporal version of the image pixels based on the transformed version of image pixels using a temporal attention component;
generating a first spatiotemporal version of the image pixels based on processing at least one of the transformed version of image pixels, the spatial version of the image pixels, or the temporal version of the image pixels using a first spatiotemporal attention component;
generating an output version of the image pixels based on the first spatiotemporal version of the image pixels and at least one of the spatial version of the image pixels or the temporal version of the image pixels; and
generating a set of output image pixels from the machine learning model based on the output version of the image pixels, wherein the set of output image pixels portray motion depicted in prompt video data for the machine learning model.

13. The processor-implemented method of claim 12, wherein:
generating the first spatiotemporal version of the image pixels comprises processing the spatial version of the image pixels using the first spatiotemporal attention component,
generating the temporal version of the image pixels comprises processing the spatial version of the image pixels using the temporal attention component, and
generating the output version of the image pixels comprises aggregating the first spatiotemporal version of the image pixels and the temporal version of the image pixels.

14. The processor-implemented method of claim 12, wherein:
generating the first spatiotemporal version of the image pixels comprises processing the transformed version of image pixels using the first spatiotemporal attention component; and
generating the temporal version of the image pixels comprises:
generating an aggregated version of the image pixels by aggregating the first spatiotemporal version of the image pixels and the spatial version of the image pixels; and
processing the aggregated version of the image pixels using the temporal attention component.

15. The processor-implemented method of claim 14, further comprising generating a second spatiotemporal version of the image pixels based on processing the aggregated version of the image pixels using a second spatiotemporal attention component, wherein generating the output version of the image pixels comprises aggregating the second spatiotemporal version of the image pixels and the temporal version of the image pixels.

16. The processor-implemented method of claim 12, wherein:
generating the spatial version of the image pixels comprises generating, for each respective frame of the transformed version of image pixels, a respective spatial self-attention value based on a respective plurality of spatial elements in the respective frame;
generating the temporal version of the image pixels comprises generating, for each respective spatial element of a version of the image pixels input for the temporal attention component, a respective temporal self-attention value based on a respective plurality of frames of the version of the image pixels input for the temporal attention component; and
generating the first spatiotemporal version of the image pixels comprises generating at least one spatiotemporal self-attention value based on a plurality of spatial elements and a plurality of frames of a version of the image pixels input for the first spatiotemporal attention component.

17. The processor-implemented method of claim 16, wherein generating the first spatiotemporal version of the image pixels comprises generating a plurality of self-attention values, each respective self-attention value of the plurality of self-attention values being generated based on a respective tubelet of a plurality of tubelets in the version of the image pixels input for the first spatiotemporal attention component.

18. The processor-implemented method of claim 17, wherein each respective tubelet of the plurality of tubelets comprises at least two spatial elements of the plurality of spatial elements across at least two frames of the plurality of frames of the version of the image pixels input for the first spatiotemporal attention component.

19. The processor-implemented method of claim 17, wherein a respective size of each respective tubelet of the plurality of tubelets was learned during training of the first spatiotemporal attention component.

20. The processor-implemented method of claim 12, wherein the machine learning model comprises a text-to-video machine learning model.
